(19) United States
(12) Patent Application Publication
(10) Pub. No.: US 2008/0307819 A1
(43) Pub. Date: Dec. 18, 2008

(54) REFRIGERATION MONITORING SYSTEM AND METHOD

(76) Inventor: Hung M. Pham, Dayton, OH (US)

Correspondence Address: HARNESS, DICKEY & PIERCE, P.L.C., P.O. BOX 828, BLOOMFIELD HILLS, MI, 48303, US

(21) Appl. No.: 12/137,191

(22) Filed: Jun. 11, 2008

Related U.S. Application Data
(60) Provisional application No. 60/943,348, filed on Jun. 12, 2007.

(51) Int. Cl. F25B 13/00; G05D 23/19

(52) U.S. Cl. 62/324.1; 237/2 B

(57) ABSTRACT

A heat-pump system may include a compressor, an outdoor heat exchanger including an outdoor coil, an indoor heat exchanger including an indoor coil, and a sensor assembly including a first sensor disposed in the outdoor coil, a second sensor disposed in the indoor coil, and a third sensor disposed between the outdoor heat exchanger and the indoor heat exchanger. A controller may receive data from the first sensor, the second sensor, and the third sensor and may determine a first system operating parameter when the heat-pump system is operating in a cooling mode and a second system operating parameter when the heat-pump system is operating in a heating mode.

### CROSS-REFERENCE TO RELATED APPLICATIONS

This application claims the benefit of U.S. Provisional Application No. 60/943,348, filed on Jun. 12, 2007. The disclosure of the above application is incorporated herein by reference.

### FIELD

The present disclosure relates to diagnostic systems and, more particularly, to a diagnostic system for use with a heating system and/or cooling system.

### BACKGROUND

The statements in this section merely provide background information related to the present disclosure and may not constitute prior art.

Heating and/or cooling systems including air-conditioning, chiller, refrigeration, and heat-pump systems may include a control and diagnostic system. The control and diagnostic system may monitor various operating parameters of the heating and/or cooling system for use by the control and diagnostic system in controlling and diagnosing operation of the heating and/or cooling system.

While conventional control and diagnostic systems adequately provide information regarding performance of the heating and/or cooling system, conventional control and diagnostic systems typically require numerous sensors located at various positions within the heating and/or cooling system. For heat-pump systems where the system operates in both a cooling mode and a heating mode, the overall number of sensors employed is further increased, as conventional systems cannot rely on use of the same sensors in both the heating mode and the cooling mode. The increased number of sensors required in a heat-pump system to detect operational parameters of the heat-pump system in both the cooling mode and the heating mode increases the overall cost and complexity of the heat-pump system.

### SUMMARY

A heat-pump system is provided and may include a compressor, an outdoor heat exchanger including an outdoor coil, an indoor heat exchanger including an indoor coil, and a sensor assembly including a first sensor disposed in the outdoor coil, a second sensor disposed in the indoor coil, and a third sensor disposed between the outdoor heat exchanger and the indoor heat exchanger. A controller may receive data from the first sensor, the second sensor, and the third sensor and may determine a first system operating parameter when the heat-pump system is operating in a cooling mode and a second system operating parameter when the heat-pump system is operating in a heating mode.

A heat-pump system is provided and may include a compressor, an outdoor heat exchanger including an outdoor coil, an indoor heat exchanger including an indoor coil, a first temperature sensor disposed in the outdoor coil, a second temperature sensor disposed in the indoor coil, and a third sensor disposed between the outdoor heat exchanger and the indoor heat exchanger. A controller may receive data from the first sensor, the second sensor, and the third sensor and may determine at least one of a discharge superheat, a subcooling, a condenser temperature difference, and a suction superheat when the heat-pump system is operating in a cooling mode and may determine at least one of a discharge superheat, a subcooling, a condenser temperature difference, and a suction superheat when the heat-pump system is operating in a heating mode.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic representation of a heat-pump system in accordance with the principles of the present teachings;

FIG. 2 is a schematic representation of a control and diagnostic system for use with the heat pump of FIG. 1;

FIG. 3 is a table defining various system operating parameters identified by the control and diagnostic system of FIG. 2;

FIG. 4 is a schematic representation of a heat-pump system in accordance with the principles of the present teachings;

FIG. 5 is a schematic representation of a control and diagnostic system for use with the heat-pump system of FIG. 4; and

FIG. 6 is a table defining various system operating parameters identified by the control and diagnostic system of FIG. 2.

### DETAILED DESCRIPTION

The following description is merely exemplary in nature and is not intended to limit the present disclosure, application, or uses. It should be understood that throughout the drawings, corresponding reference numerals indicate like or corresponding parts and features.

With reference to the figures, a control and diagnostic system 10 is provided for use with a heating and/or cooling system 12. The control and diagnostic system 10 may monitor various operating parameters of the heating and/or cooling system 12 for use by the control and diagnostic system 10 in controlling and diagnosing the heating and/or cooling system 12. The heating and/or cooling system 12 may be an air-conditioning system operating in a cooling mode, a chiller system, a refrigeration system, a heating system operating in a heating mode, or a heat-pump system operating in both a heating mode and a cooling mode.

While the heating and cooling system 12 will be described hereinafter and shown in the drawings as a heat-pump system operational in both a heating mode and a cooling mode, the heating and/or cooling system 12 could be configured to operate solely in a heating mode or solely in a cooling mode. Furthermore, while the control and diagnostic system 10 will be described and shown hereinafter in the drawings as being associated with a heat-pump system 12, the control and diagnostic system 10 could be associated with a system operating solely in a heating mode or associated with a system operating solely in a cooling mode.

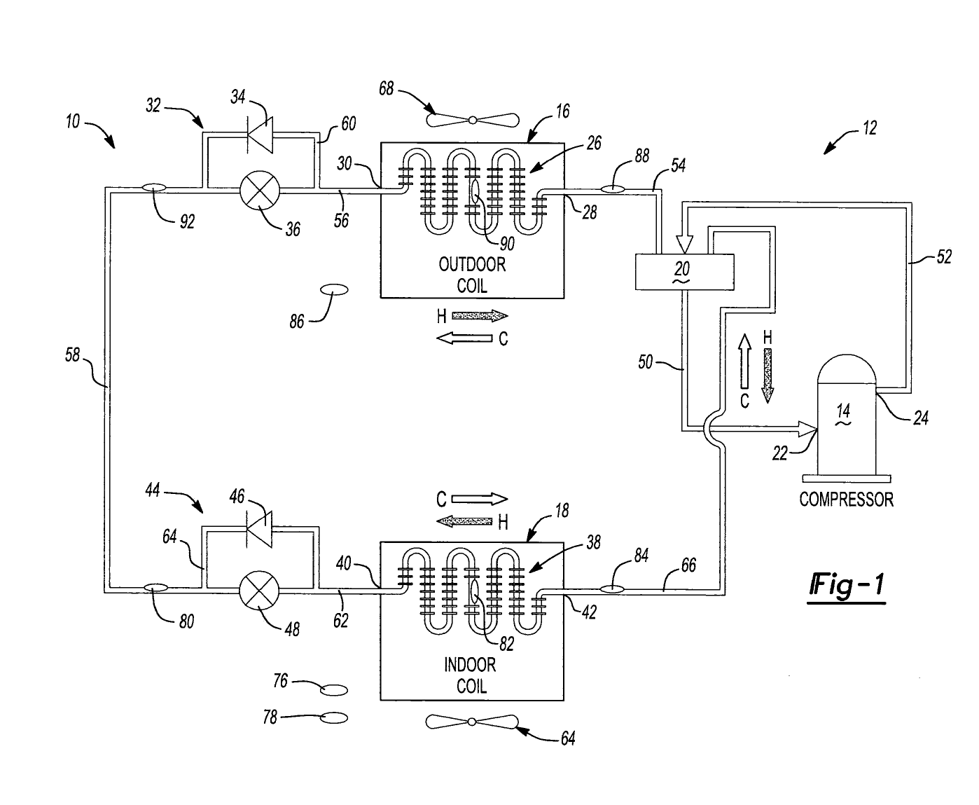

With reference to FIG. 1, the heat-pump system 12 is shown including a compressor 14, an outdoor heat exchanger 16, an indoor heat exchanger 18, and a four-way valve 20. The compressor 14 is fluidly coupled to the outdoor heat exchanger 16, indoor heat exchanger 18, and four-way valve 20 and applies a pressure on a refrigerant disposed within the heat-pump system 12 to circulate the refrigerant within the heat-pump system 12 and among the outdoor heat exchanger 16, indoor heat exchanger 18, and four-way valve 20. The compressor 14 may include a suction inlet 22 fluidly coupled to the four-way valve 20 and a discharge outlet 24 similarly fluidly coupled to the four-way valve 20.

The outdoor heat exchanger 16 functions as a condenser in the cooling mode and functions as an evaporator in the heating mode and includes an outdoor coil 26, a first end 28, and a second end 30. The first end 28 is fluidly coupled to the four-way valve 20 and the second end 30 is fluidly coupled to a valve arrangement 32.

The valve arrangement 32 may include a check valve 34 and a thermostatic-expansion valve or an electronic-expansion valve 36 disposed proximate to the second end 30 of the outdoor heat exchanger 16. While the thermostatic-expansion valve and electronic-expansion valve 36 are disclosed, any suitable expansion device may be employed including, for example, a valve or a capillary tube. In the cooling mode, the check valve 34 and expansion valve 36 permit refrigerant to flow from the second end 30 of the outdoor heat exchanger 16 toward the indoor heat exchanger 18. In the heating mode, refrigerant from the indoor heat exchanger 18 is restricted from flowing through the check valve 34 and into the outdoor heat exchanger 16. By restricting flow through the check valve 34, refrigerant is forced to flow through the expansion valve 36 prior to reaching the outdoor heat exchanger 16 to expand the refrigerant prior to reaching the outdoor heat exchanger 16.

The indoor heat exchanger 18 functions as an evaporator in the cooling mode and functions as a condenser in the heating mode and may include an indoor coil 38, a first end 40, and a second end 42. The first end 40 may be fluidly coupled to a valve arrangement 44 while the second end may be fluidly coupled to the four-way valve 20.

The valve arrangement 44 may include a check valve 46 and a thermostatic expansion valve 48. While a thermostatic expansion valve 48 is disclosed, any suitable expansion valve may be employed. In the cooling mode, the check valve 46 restricts flow of refrigerant from the outdoor heat exchanger 16 to the indoor heat exchanger 18. Restricting flow of refrigerant through the check valve 46 directs the refrigerant from the outdoor heat exchanger 16 through the expansion valve 48 to expand the refrigerant prior to reaching the indoor heat exchanger 18. In the heating mode, refrigerant may freely flow from the first end 40 of the indoor heat exchanger 18 through each of the check valve 46 and expansion valve 48 to allow the refrigerant to reach the outdoor heat exchanger 16.

With reference to FIG. 1, operation of the heat-pump system 12 will be described in detail. In the cooling mode, refrigerant flows through the heat-pump system 12 in a direction generally labeled by arrow “C.” The compressor 14 draws gaseous, low-pressure refrigerant from a conduit 50 extending generally between the four-way valve 20 and the inlet 22 of the compressor 14. The compressor 14 pressurizes the low-pressure refrigerant and discharges the refrigerant from the compressor at the discharge outlet 24 once pressurized to a discharge pressure. The discharge-pressure refrigerant travels along a conduit 52 extending between the discharge outlet 24 of the compressor 14 and the four-way valve 20.

In the cooling mode, the four-way valve 20 is in a position such that refrigerant received from the discharge outlet 24 of the compressor 14 is directed to the first end 28 of the outdoor heat exchanger 16. The refrigerant travels from the four-way valve 20 along a conduit 54 extending between the four-way valve 20 and the first end 28 of the outdoor heat exchanger 16.

Once the discharge-pressure refrigerant reaches the outdoor heat exchanger 16, the discharge-pressure refrigerant enters the outdoor coil 26 and begins to change phase from a gas to a liquid. In so doing, the refrigerant rejects heat, which is removed from the outdoor heat exchanger 16 by circulating air therethrough via a fan 68. Upon reaching the second end 30 of the outdoor coil 26, the refrigerant is in a liquid state and travels toward the valve arrangement 32 along a conduit 56 extending generally between the valve arrangement 32 and the second end 30 of the outdoor heat exchanger 16.

The refrigerant travels along conduit 56 and encounters the expansion valve 36. The expansion valve 36 permits the liquid refrigerant to travel therethrough and toward the valve arrangement 44 along a conduit 58 extending generally between the expansion valve and the valve arrangement 44. While some of the liquid travels through the expansion valve 36 and along conduits 56 and 58 toward the valve arrangement 44, a portion of the liquid refrigerant exits the outdoor heat exchanger 16 and travels along the conduit 56 and is diverted away from the expansion valve 36 and toward the check valve 34 along a conduit 60 extending between conduits 56 and 58. The refrigerant traveling along conduit 60 is permitted to pass through the check valve 34 and travel along conduit 60 until encountering conduit 58. The liquid refrigerant travels along conduit 58 and toward valve arrangement 44.

The liquid refrigerant travels along conduit 58 until encountering the valve arrangement 44. At this point, a portion of the liquid refrigerant encounters the expansion valve 48 and is expanded by the expansion valve 48 such that a pressure of the liquid refrigerant is reduced. The reduced-pressure liquid refrigerant exits the expansion valve 48 and travels along a conduit 62 extending generally between the expansion valve 48 and the first end 40 of the indoor heat exchanger 18. A portion of the liquid refrigerant traveling along conduit 58 encounters a conduit 64 extending generally between conduit 58 and conduit 62.

The liquid refrigerant traveling along conduit 64 encounters the check valve 46 and is restricted from traveling further along conduit 64 to conduit 62 by the check valve 46. Because the check valve 46 restricts the liquid refrigerant from traveling from conduit 58 to conduit 62 along conduit 64, the liquid refrigerant traveling in conduit 64 is diverted back toward conduit 58 and through the expansion valve 48. Cooperation between conduit 64 and check valve 46 forces all of the liquid refrigerant traveling from the valve arrangement 32 toward the valve arrangement 44 along conduit 58 through the expansion valve 48 to reduce a pressure of the liquid refrigerant (i.e., to expand the liquid refrigerant) prior to the refrigerant encountering the indoor heat exchanger 18.

Once the expanded liquid refrigerant enters the indoor heat exchanger 18 at the first end 40, the expanded liquid refrigerant enters the indoor coil 38. Once the expanded liquid refrigerant enters the indoor coil 38, the expanded liquid refrigerant begins to change phase from a liquid to a gas. In doing so, the liquid refrigerant absorbs heat surrounding the indoor coil 38, thereby cooling a space proximate to the indoor heat exchanger 18.

A fan 64 may be disposed proximate to the indoor coil 38 to circulate air through the indoor coil 38 to direct the cooled air created by the absorption of heat by the indoor coil 38 to a space to be cooled (i.e., a building, room, refrigerator, etc.). Once the refrigerant has sufficiently changed phase from a liquid to a gas, the gaseous refrigerant exits the indoor coil 38 at the second end 42 and travels along a conduit 66 extending between the indoor heat exchanger 18 and the four-way valve 20. Once the gaseous refrigerant encounters the four-way valve 20, the four-way valve 20 directs the low-pressure gaseous refrigerant along conduit 50 and toward the inlet 22 of the compressor 14 to begin the cycle anew.

With continued reference to FIG. 1, operation of the heat-pump system 12 in a heating mode will be described in detail. As described above with the cooling mode, the compressor 14 begins the cycle by drawing low-pressure, gaseous refrigerant into the compressor 14 at the inlet 22. The compressor 14 pressurizes the low-pressure refrigerant to discharge pressure and directs the discharge-pressure gas to the four-way valve 20.

The four-way valve 20 directs the discharge-pressure gas through the heat-pump system 12 in a direction indicated by the “H” arrow. The four-way valve 20 directs the discharge-pressure gas along conduit 66 from the four-way valve 20 toward the indoor heat exchanger 18. The discharge-pressure gas is received by the indoor heat exchanger 18 at the second end 42. The discharge-pressure gas is received into the indoor heat exchanger 18 and travels through the indoor coil 38.

As the discharge-pressure gas travels through the indoor coil 38, the discharge-pressure gas changes state from a gas to a liquid. As the refrigerant changes state from a gas to a liquid, the refrigerant rejects heat to an area generally surrounding the indoor heat exchanger 18. The rejected heat may be transferred from the indoor heat exchanger 18 to an area surrounding the indoor heat exchanger 18 by the fan 64 circulating air through the indoor coil 38 to heat the area generally surrounding the indoor heat exchanger 18.

Once the refrigerant has sufficiently changed state from a gas to a liquid, the liquid refrigerant exits the indoor heat exchanger 18 at the first end 40 and travels along conduit 62 toward the valve arrangement 44. The liquid refrigerant is permitted to flow through the expansion valve 48 and check valve 46 toward conduit 58 and valve arrangement 32.

Once the liquid refrigerant encounters the valve arrangement 32, a portion of the liquid refrigerant passes through the expansion valve 36 and is expanded by the expansion valve 36 prior to reaching the outdoor heat exchanger 16. A portion of the liquid refrigerant from conduit 58 travels through conduit 60 and encounters the check valve 34. The check valve restricts flow of liquid refrigerant from conduit 58 to conduit 56 along conduit 60 and, therefore, forces the liquid refrigerant toward and through the expansion valve 36. Therefore, cooperation between the check valve 34 and the expansion valve 36 reduces a pressure of the liquid refrigerant (i.e., expands the liquid refrigerant) prior to the liquid refrigerant entering the outdoor heat exchanger 16.

Upon entering the outdoor heat exchanger 16, the liquid refrigerant travels through the outdoor coil 26 and changes state from a liquid to a gas. In so doing, the liquid refrigerant absorbs heat from an area generally surrounding the outdoor heat exchanger. By absorbing heat, an area generally surrounding the outdoor heat exchanger 16 is cooled. The cool air may be removed from the area surrounding the outdoor heat exchanger 16 through use of the fan 68 positioned in close proximity to the outdoor coil 26. The fan 68 may circulate air through the outdoor coil 26 to remove the cooled air from the outdoor heat exchanger 16.

Once the gas has changed phase from a liquid to a low-pressure gas, the low-pressure gas exits the outdoor heat exchanger 16 at the first end 28 and travels along conduit 54 toward the four-way valve 20. The four-way valve 20 directs the low-pressure refrigerant along conduit 50 and toward the compressor 14. The low-pressure refrigerant is drawn in by the compressor 14 at the inlet 22 to begin the cycle anew.

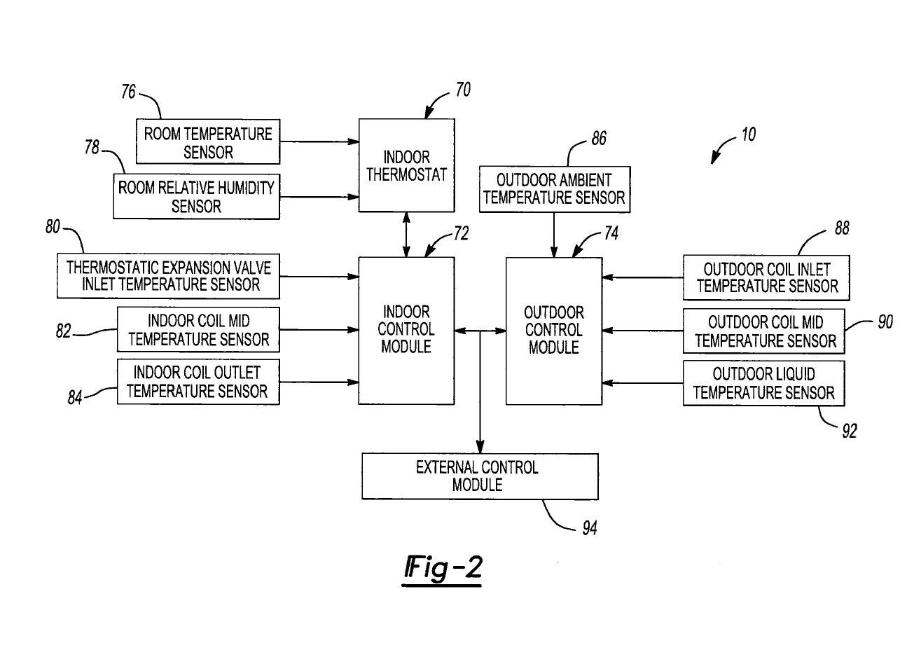

With particular reference to FIGS. 1 and 2, the control and diagnostic system 10 will be described in detail. The control and diagnostic system 10 may include a distributed architecture including a thermostat 70, an indoor control module 72, and an outdoor control module 74. The thermostat 70 may be positioned within a space to be heated or cooled such as within a room of a building, for example. The thermostat 70 may be in communication with a temperature sensor 76 disposed within the space to be heated and/or cooled to provide the thermostat 70 with an indication of the temperature of the space to be heated and/or cooled. The thermostat 70 may also be in communication with a relative humidity sensor 78 that is positioned within the space to be heated and/or cooled to provide the thermostat 70 with an indication of the relative humidity within the space to be heated and/or cooled.

The indoor control module 72 may be in communication with the thermostat 70 via a hard-wire connection or via a wireless connection. The indoor control module 72 may also be in communication with the outdoor control module 74 via a hard-wire connection or via a wireless connection. While the indoor control module 72 and the outdoor control module 74 are shown as separate modules, the indoor control module 72 and outdoor control module 74 may be incorporated into a single control module. If the indoor control module 72 and the outdoor control module 74 are incorporated into a single control module, the single control module may be in communication with the thermostat 70.

The indoor control module 72 may be in communication with various temperature sensors disposed within the heat-pump system 12. In one configuration operating in cooling mode, the indoor control module may be in communication with a temperature sensor 80 disposed generally proximate to a first end of expansion valve 48 of the valve arrangement 44. The temperature sensor 80 may detect a temperature of the refrigerant within conduit 58 near an inlet of the expansion valve 48 and provide a signal indicative of the liquid refrigerant temperature to the indoor control module 72. A temperature sensor 82 may be disposed within the indoor heat exchanger 18 and may be positioned near a midpoint of the indoor coil 38. The temperature sensor 82 may detect a temperature of the refrigerant circulating within the indoor coil 38 and may provide a signal to the indoor control module 72 indicative of a temperature of the refrigerant at a midpoint of the indoor coil 38.

The indoor control module 72 may also be in communication with a temperature sensor 84 disposed proximate to an outlet of the indoor heat exchanger 18. The temperature sensor 84 may be positioned proximate to the second end 42 of the indoor heat exchanger 18 and may detect a temperature of the refrigerant proximate to the second end 42 of the indoor heat exchanger 18. The temperature sensor 84 may provide a signal to the indoor control module 72 indicative of the temperature of the refrigerant proximate to the second end 42 of the indoor heat exchanger 18.

The outdoor control module 74 may similarly be in communication with a plurality of sensors disposed within the heat-pump system 12. The outdoor control module 74 may be in communication with an outdoor ambient temperature sensor 86 that provides the outdoor control module 74 with a signal indicative of a temperature of the outdoor ambient conditions generally proximate to the outdoor heat exchanger 16. The outdoor control module 74 may also be in communication with a temperature sensor 88 disposed proximate to the first end 28 of the outdoor heat exchanger 16. The temperature sensor 88 may provide the outdoor control module 74 with a signal indicative of the temperature of the refrigerant circulating within conduit 54 generally proximate to the first end 28 of the outdoor heat exchanger 16.

A temperature sensor 90 may be positioned in the outdoor heat exchanger 16 to provide the outdoor control module 74 with a signal indicative of a temperature of the refrigerant circulating within the outdoor heat exchanger 16. The temperature sensor 90 may be positioned near a midpoint of the outdoor coil 26 to provide the outdoor control module 74 with a signal indicative of a temperature of the refrigerant near a midpoint of the outdoor coil 26. In addition, a temperature sensor 92 may be positioned along conduit 56 proximate to the second end 30 of the outdoor heat exchanger 16. The temperature sensor 92 may provide a signal to the outdoor control module 74 indicative of a temperature of liquid refrigerant within conduit 56. The temperature sensor 92 may be positioned along conduit 56 either proximate to the second end 30 of the outdoor heat exchanger 16 or along conduit 58 proximate to the expansion valve 36 of the valve arrangement 32. In either position, the temperature sensor 92 may provide a signal to the outdoor control module 74 indicative of a temperature of liquid refrigerant at a position along conduit 56 and/or 58.

While the temperature sensors 80, 92 are shown as being separated along conduit 58 extending between the outdoor heat exchanger 16 and the indoor heat exchanger 18, a single temperature sensor could alternatively be used to measure a liquid temperature along conduit 58. Two sensors are generally used for a “split system” where the outdoor heat exchanger 16 is separated a predetermined distance from the indoor heat exchanger 18. For a “packaged system” where the outdoor heat exchanger 16 is in close proximity to the indoor heat exchanger 18, a single temperature sensor may be used.

Placement of the various temperature sensors 80, 82, 84, 86, 88, 90, 92, throughout the heat-pump system 12 allows the indoor control module 72 and outdoor control module 74 to determine various system operating parameters. Specifically, for both of the cooling mode and the heating mode, the indoor control module 72 and outdoor control module 74 are able to determine a discharge superheat of the heat-pump system 12, a subcooling of the heat-pump system 12, a condenser temperature difference, and a suction superheat. Locating the temperature sensors 80, 82, 84, 86, 88, 90, 92 within the heat-pump system 12, as shown, allows the indoor control module 72 and outdoor control module 74 to determine each of the operating parameters outlined above (i.e., discharge superheat, subcooling, condenser temperature difference, and suction superheat) without requiring individual sensors for each system parameter. The same temperature sensors may be used in the cooling mode and the heating mode to determine the system operating conditions during both the cooling mode and the heating mode.

Furthermore, such operating parameters may be used to determine a compressor operating envelope and compare such operating envelope to a predetermined or stored compressor operating envelope. For example, evaporator temperature, condenser temperature, suction superheat, and discharge superheat may be used to determine a compressor operating envelope, which may be compared to a predetermined or stored compressor operating envelope to make sure that compressor 14 is operating within an acceptable range.

While the indoor control module 72 and outdoor control module 74 are described as determining system operating conditions such as discharge superheat, subcooling, condenser temperature difference, and suction superheat based on information received from the various temperature sensors 80, 82, 84, 86, 88, 90, 92 positioned within the heat-pump system 12, the operating conditions could alternatively or additionally be determined by an external control module 94 that may be in communication with each of the indoor control module 72 and outdoor control module 74. The external control module 94 may be a hand-held device and may communicate with the indoor control module 72, outdoor control module 74, and/or temperature sensors 80, 82, 84, 86, 88, 90, 92 via a wired or wireless connection to retrieve operating parameters (i.e., discharge superheat, subcooling, condenser temperature difference, and suction superheat) and/or historical data of such operating parameters. Such historical data may be compared to current operating data to diagnose the heat-pump system 12.

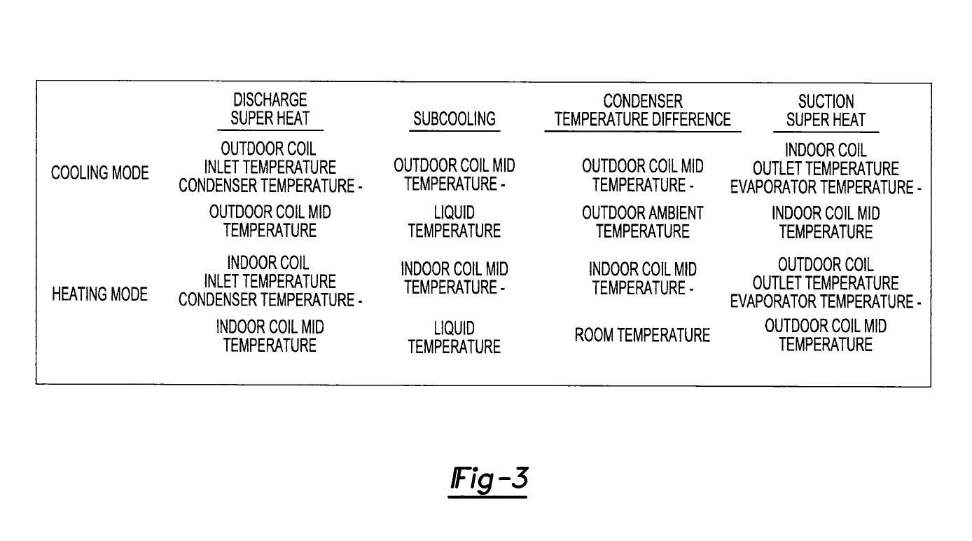

The external control module 94 may receive the sensor data from each of the indoor control module 72 and outdoor control module 74 to determine the system operating parameters and may be remotely located from the indoor control module 72 and outdoor control module 74. The external control module 94 may also receive the system operating conditions as determined by the indoor control module 72 and outdoor control module 74 for comparison with system operating conditions as determined by the external control module 94. In either configuration, the system operating conditions may be determined by the respective control modules 72, 74, 94, using the relationships shown in FIG. 3.

With reference to FIG. 3, calculation of the system operating parameters (i.e., discharge superheat, subcooling, condenser temperature difference, and suction superheat) will be described in detail. When the heat-pump system 12 is operating in the cooling mode, the discharge superheat of the heat-pump system 12 may be determined by subtracting the temperature of the outdoor coil midpoint temperature from the outdoor coil inlet temperature. As described above, when the heat-pump system 12 is operating in the cooling mode, refrigerant flows along conduit 54 from the four-way valve 20 toward the outdoor heat exchanger 16. Because the temperature sensor 88 is associated with conduit 54, the temperature sensor 88 is able to detect a temperature of the refrigerant near the inlet of the outdoor heat exchanger 16 when the heat-pump system 12 is functioning in the cooling mode. The temperature of the refrigerant near the midpoint of the outdoor coil 26 may be obtained by the temperature sensor 90 located near the midpoint of the outdoor coil 26.

The information received by the outdoor control module 72 from the temperature sensor 88 disposed proximate to the first end 28 (i.e., the inlet in the cooling mode) of the outdoor heat exchanger 16 and the temperature sensor 90 disposed near a midpoint of the outdoor coil 26 may be used by the outdoor control module 74 in determining the discharge superheat by subtracting the temperature near the midpoint of the outdoor coil 26 from the temperature of the refrigerant proximate to the first end 28 of the outdoor heat exchanger 16.

The outdoor control module 74 may communicate the sensor data received from temperature sensors 88, 90 to the external control module 94 and/or may transmit the determined discharge superheat value to the external control module 94. The external control module 94 may use the sensor data to determine the discharge superheat independently by subtracting the temperature at the midpoint of the outdoor coil 26 from the temperature of the refrigerant proximate to the first end 28 of the outdoor heat exchanger 16 for comparison to the discharge superheat value received from the outdoor control module 74. Alternatively, the external control module 94 may use the sensor data received from the outdoor control module 74 to calculate the discharge superheat of the heat-pump system 12 without comparison to the calculated discharge superheat performed by the outdoor control module 74.

The outdoor control module 74 may determine the subcooling of the heat-pump system 12 by subtracting a temperature of the liquid refrigerant near an outlet of the outdoor heat exchanger 16 from a temperature near the midpoint of the outdoor coil 26. As described above, the outdoor control module 74 may receive a signal from the temperature sensor 92 disposed near an outlet of the outdoor heat exchanger 16, which is indicative of a temperature of the liquid refrigerant exiting the outdoor heat exchanger 16 in the cooling mode. The outdoor control module 74 may also receive a signal from the temperature sensor 90 disposed near a midpoint of the outdoor coil 26 that is indicative of a temperature near the midpoint of the outdoor coil 26. Once the information is received from the temperature sensors 90, 92, the outdoor control module 74 may determine a subcooling of the heat-pump system 12 by subtracting the value received from temperature sensor 92 from that received from temperature sensor 90. As noted above with respect to calculation of the discharge superheat, the outdoor control module 74 may similarly communicate the sensor data and/or the determined subcooling value to the external control module 94. The external control module 94 may independently determine the subcooling of the heat-pump system 12 and may compare the determined subcooling value to the subcooling value received from the outdoor control module 74.

The outdoor control module 74 may determine the condenser temperature difference by subtracting the outdoor ambient temperature from the temperature near the midpoint of the outdoor coil 26. The outdoor control module 74 may determine the condenser temperature difference once the signals from the outdoor ambient temperature sensor 86 and the temperature sensor 90 located near a midpoint of the outdoor coil 26 are received. Once the signals are received from the respective temperature sensors 86, 90, the outdoor control module 74 can determine the condenser temperature difference by subtracting the outdoor ambient temperature from the temperature taken near the midpoint of the outdoor coil 26. The outdoor control module 74 may communicate the sensor data and/or the determined condenser temperature difference to the external control module 94. The external control module 94 may independently determine the condenser temperature difference and may compare the determined condenser temperature difference with the condenser temperature difference received from the outdoor control module 74.

In the cooling mode, the indoor control module 72 may determine the suction superheat of the heat-pump system 12 by subtracting a temperature near the midpoint of the indoor coil 38 from a temperature near an outlet of the indoor heat exchanger 18. The indoor control module 72 may receive a signal from the temperature sensor 82 located near the midpoint of the indoor coil 38 indicative of a temperature near the midpoint of the indoor coil 38. The indoor control module 72 may receive a signal from the temperature sensor 84 indicative of a temperature near the outlet of the indoor heat exchanger 18. Once the sensor data is received by the indoor control module 72, the indoor control module 72 may determine the suction superheat of the heat-pump system 12 by subtracting the temperature near the midpoint of the indoor coil 38 from the temperature near the outlet of the indoor heat exchanger 18. The indoor control module 72 may communicate the suction superheat of the heat-pump system 12 to the external control module 94 and/or the sensor data received from temperature sensors 82, 84. The external control module 94 may independently determine the suction superheat of the heat-pump system 12 based on the received sensor data and may compare the determined suction superheat to the suction superheat value received from the indoor control module 72.

Once the outdoor control module 74 determines the suction superheat of the heat-pump system 12, the suction superheat and/or sensor data may be communicated to the external control module 94. The external control module 94 may use the sensor data to independently determine the suction superheat and may compare the determined suction superheat to the suction superheat value received from the outdoor control module 74.

In the heating mode, the outdoor control module 74 may determine the suction superheat of the heat-pump system 12 once the temperature near the midpoint of the outdoor coil 26 and the temperature of the liquid refrigerant exiting the outdoor heat exchanger 16 are known. The outdoor control module 74 may receive a signal from the temperature sensor 90 disposed near the midpoint of the outdoor coil 26 and may also receive a signal from the temperature sensor 92 disposed near an outlet of the outdoor heat exchanger 16. Once the outdoor control module 74 receives the signal from the temperature sensor 90 disposed near the midpoint of the outdoor coil 26 and the signal from the temperature sensor 92 disposed near an outlet of the outdoor heat exchanger 16, the outdoor control module 74 can determine the suction superheat of the heat-pump system 12 by subtracting the temperature near the midpoint of the outdoor coil from the temperature near the outlet of the outdoor heat exchanger 16.

In the heating mode, the indoor control module 72 may determine the discharge superheat by subtracting a temperature near the midpoint of the indoor coil 38 from a temperature near an inlet of the indoor heat exchanger 18. The indoor control module 72 may receive a signal from the temperature sensor 82 disposed near the midpoint of the indoor coil 38 and may also receive a signal from the temperature sensor 80 disposed along conduit 58. The temperature sensor 82 may provide a signal to the indoor control module 72 indicative of a temperature near the midpoint of the indoor coil while the temperature sensor 80 may provide a signal to the indoor control module 72 indicative of a temperature near the inlet of the indoor heat exchanger 18. Once the signals are received from the respective sensors 80, 82, the indoor control module 72 may determine a discharge superheat by subtracting the temperature at the midpoint of the indoor coil 38 from the temperature taken at an inlet of the indoor heat exchanger 18. Once the indoor control module 72 determines the discharge superheat of the heat-pump system 12, the discharge superheat and/or sensor data may be communicated to the external control module 94. The external control module 94 may independently determine the discharge superheat and may compare the determined discharge superheat to the discharge superheat value received from the indoor control module 72.

In the heating mode, the indoor control module 72 may determine the subcooling of the heat-pump system 12 by subtracting a temperature proximate to the expansion valve 48 received from temperature sensor 80 from the temperature near the midpoint of the indoor coil 38 received from temperature sensor 82. Once the sensor data is received by the indoor control module 72 from the respective temperature sensors 80, 82, the indoor control module 72 can determine the subcooling of the heat-pump system 12 by subtracting the temperature near the expansion valve 48 received from temperature sensor 80 from the temperature near the midpoint of the indoor coil 38 received from the temperature sensor 82. Once the subcooling of the heat-pump system 12 is determined by the indoor control module 72, the indoor control module 72 may communicate the sensor data and/or the subcooling value to the external control module 94. The external control module 94 may independently determine the subcooling of the heat-pump system 12 and may compare the determined subcooling to the subcooling value received from the indoor control module 72.

In the heating mode, the condenser temperature difference may be determined by the indoor control module 72 by subtracting a temperature of the space to be heated from the temperature near the midpoint of the indoor coil 38. The indoor control module 72 may receive a value indicative of the temperature of the room to be heated from the temperature sensor 76 via the thermostat 70 and may receive a value indicative of the temperature near the midpoint of the indoor coil 38 from the temperature sensor 82. Once the indoor control module 72 has received the sensor data from the thermostat 70 and temperature sensor 82, the indoor control module 72 can determine the condenser temperature difference by subtracting the temperature of the room to be heated from the temperature near the midpoint of the indoor coil 38. The indoor control module 72 may communicate the determined condenser temperature difference and/or sensor data to the external control module 94. The external control module 94 may independently determine the condenser temperature difference based on the sensor data received from the indoor control module 72 and may compare the determined condenser temperature difference to the condenser temperature difference received from the indoor control module 72.

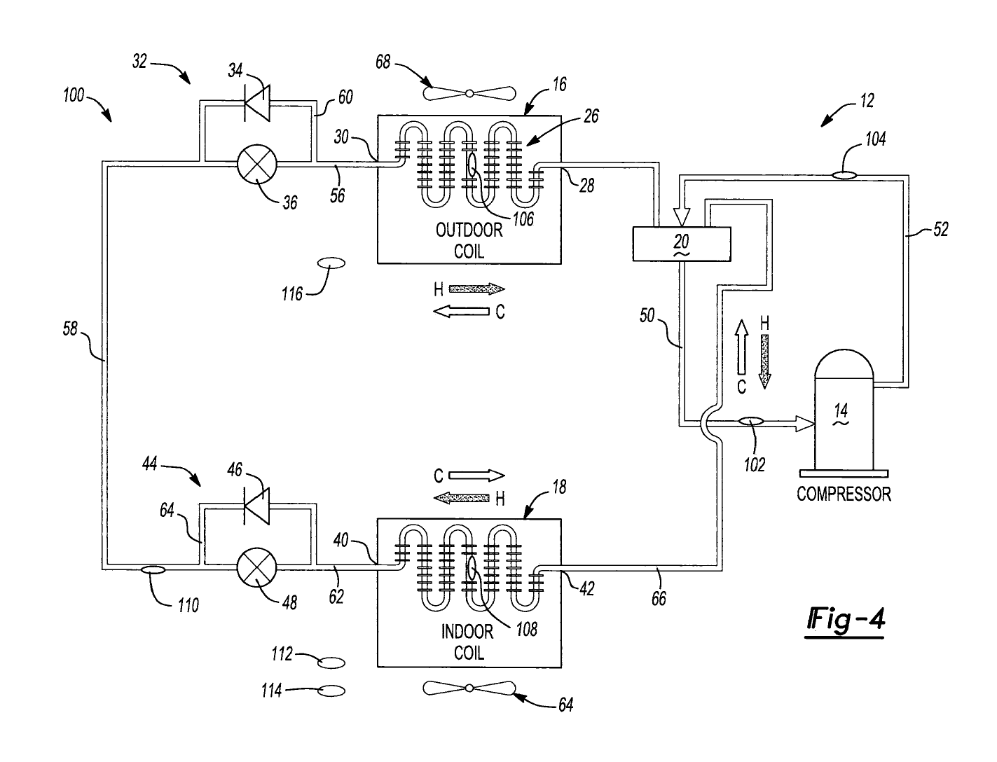

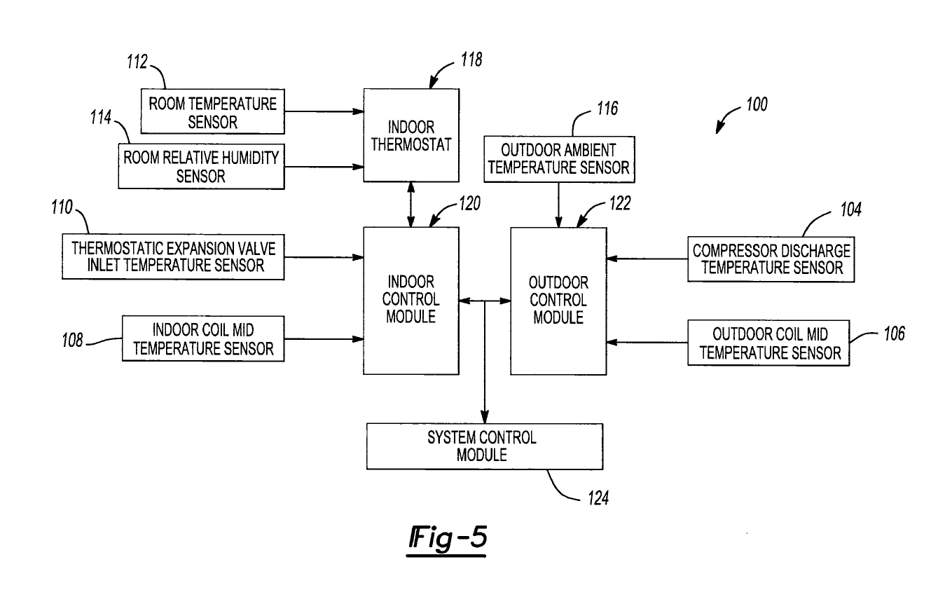

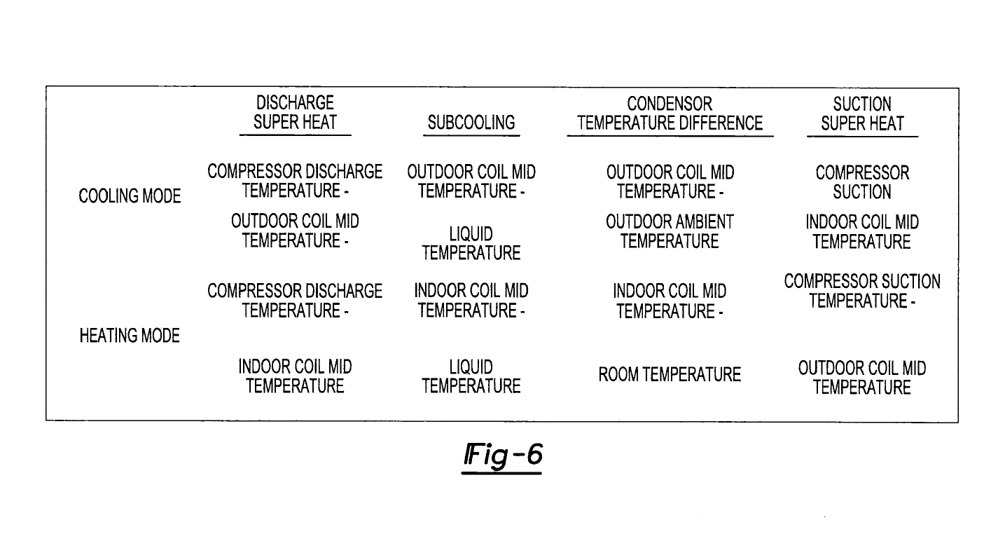

With reference to FIGS. 4-6, the heat-pump system 12 is shown to include a control and diagnostics system 100. As noted above with respect to the control and diagnostics system 10, the control and diagnostics system 100 could be incorporated into any heating and/or cooling system. While the control and diagnostics system 100 may be incorporated into any heating and/or cooling system including systems that include only a heating cycle and systems that include only a cooling cycle, the control and diagnostics system 100 will be hereinafter described and shown in the drawings as associated with the heat-pump system 12, which operates in both the cooling mode and the heating mode, as described above.

The control and diagnostics system 100 may monitor various operating parameters of the heat-pump system 12 to both control and diagnose the heat-pump system 12. Specifically, the control and diagnostics system 100 may include a series of temperature sensors disposed at various locations of the heat-pump system 12 for use by the control and diagnostics system 10. The various locations of the temperature sensors of the control and diagnostics system 100 within and around the heat-pump system 12 allow the control and diagnostics system 100 to obtain information regarding the performance of the heat-pump system 12 when the heat-pump system 12 is operating in either the heating mode or the cooling mode.

The control and diagnostics system 100 may include a temperature sensor 102 disposed proximate to an inlet or suction side of the compressor 14 as well as a temperature sensor 104 located proximate to an outlet of the compressor 14 and along conduit 52. The temperature sensor 102 may be positioned generally near the inlet of the compressor 14 and may sense a temperature at the suction side of the compressor 14. The temperature sensor 104 may be disposed proximate to the outlet of the compressor 14 and may sense a discharge temperature of the compressor 14.

The control and diagnostics system 100 may also include a temperature sensor 106 located near a midpoint of the outdoor coil 26 and may further include a temperature sensor 108 located near a midpoint of the indoor coil 38. A temperature sensor 110 may be disposed proximate to the expansion valve 48 for detecting a temperature near an inlet of the expansion valve 48 when the heat-pump system 12 is operating in the cooling mode. In addition, the control and diagnostic system 100 may also include a room temperature sensor 112 and a room relative humidity sensor 114 each disposed within an area to be heated and/or cooled. An outdoor ambient temperature sensor 116 may be positioned in an area proximate to the outdoor heat exchanger 16 for sensing a temperature of an area generally surrounding the outdoor heat exchanger 16.

The control and diagnostic system 100 may include a thermostat 118 located within or proximate to the area to be heated and/or cooled. The thermostat 118 may be in communication with the room temperature sensor 112 and the room relative humidity sensor 114. The thermostat 118 may receive a signal from the room temperature sensor 112 indicative of a temperature within the area to be heated and/or cooled and may similarly receive a signal from the room relative humidity sensor 114 indicative of a relative humidity within the area to be heated and/or cooled.

An indoor control module 120 may be in communication with the thermostat 118 as well as in communication with the temperature sensor 110 disposed proximate to the expansion valve 48 as well as the temperature sensor 108 disposed near the midpoint of the indoor coil 38. The indoor control module 120 may also be in communication with a system control module 124 and may provide the system control module 124 with sensor data received from the room temperature sensor 112 and room relative humidity sensor 114 via the thermostat 118 may also provide the system control module 124 with sensor data received from the temperature sensors 108, 110. As with the external control module 94, the system control module 124 may be remotely located from the indoor control module 120 and outdoor control module 122.

An outdoor control module 122 may be in communication with the indoor control module 120. The outdoor control module 122 may receive a signal from the outdoor ambient temperature sensor 116 indicative of a temperature generally surrounding the outdoor heat exchanger 16. The outdoor control module 122 may also receive a signal from the temperature sensor 104 disposed proximate to the outlet of the compressor 14 and may receive a signal from the temperature sensor 106 disposed near the midpoint of the outdoor coil 26. The outdoor control module 122 may be in communication with the system control module 124 and may communicate sensor data received from the temperature sensors 104, 106, 116 to the system control module 124.

While the indoor control module 120 and outdoor control module 122 are described and shown as being separate control modules, the indoor control module 120 and outdoor control module 122 may be a single control module receiving information from each of the respective sensors 104, 106, 108, 110, 112, 114, 116 and communicating with the system control module 124. If the indoor control module 120 and outdoor control module 122 are integrated into a single control module, the single control module may be associated with the outdoor heat exchanger 16, indoor heat exchanger 18, or compressor 14.

With continued reference to FIGS. 4-6, operation of the control and diagnostics system will be described in detail. When the heat-pump system 12 is operating in the cooling mode, the control and diagnostic system 100 may determine operating parameters of the heat-pump system 12 such as discharge superheat, subcooling, condenser temperature difference, and suction superheat. Similarly, when the heat-pump system 12 is operating in a heating mode, the control and diagnostic system 100 may determine various operating conditions of the heat-pump system 12 such as discharge superheat, subcooling, condenser temperature difference, and suction superheat.

When the heat-pump system 12 is operating in the cooling mode, the control and diagnostics system 100 may determine a discharge superheat of the heat-pump system 12 by subtracting a temperature near the midpoint of the outdoor coil 26 from the temperature near the discharge of the compressor 14. As described above, the outdoor control module 122 may receive a signal from the temperature sensor 104 disposed proximate to an outlet of the compressor 14 indicative of the discharge temperature of the compressor 14 and may also receive a signal from the temperature sensor 106 disposed near the midpoint of the outdoor coil 26. Once the outdoor control module 122 receives the signal from the respective sensors 104, 106, the outdoor control module 122 may calculate the discharge superheat of the heat-pump system 12 by subtracting the temperature near the midpoint of the outdoor coil 26 from the discharge temperature of the compressor 14.

The outdoor control module 122 may communicate the sensor data received from the sensors 104, 106, 116 as well as the determined discharge superheat to the system control module 124. The system control module 124 may use the sensor data to independently determine the discharge superheat of the heat-pump system 12 and may compare the determined discharge superheat to the discharge superheat value received from the outdoor control module 122.

The outdoor control module 122 may determine the subcooling of the heat-pump system 12 by subtracting a temperature proximate to the expansion valve 48 from the temperature near the midpoint of the outdoor coil 26. As noted above, the outdoor control module 122 may receive a signal from the temperature sensor 106 located near the midpoint of the outdoor coil 26, which is indicative of a temperature near the midpoint of the outdoor coil 26. The outdoor control module 122 may also receive a signal from the temperature sensor 110 disposed proximate to an inlet of the expansion valve 48, which is indicative of a temperature of the liquid refrigerant prior to the refrigerant passing through the expansion valve 48. Once the outdoor control module 122 receives the signals from the respective sensors 106, 110, the outdoor control module 122 may determine a subcooling of the heat-pump system 12 by subtracting the temperature proximate to the expansion valve 48 from the temperature near the midpoint of the outdoor coil 26.

Once the subcooling of the heat-pump system 12 is determined by the outdoor control module 122, the outdoor control module 122 may communicate the determined subcooling to the system control module 124. The system control module 124 may calculate the subcooling for the heat-pump system 12 based on the sensor data received from the outdoor control module 122 and may compare the determined subcooling value to the subcooling value received from the outdoor control module 122.

A condenser temperature difference may be determined by the outdoor control module 122 once the outdoor ambient temperature and temperature near the midpoint of the outdoor coil 26 are determined. As noted above, the outdoor control module 122 may receive a signal from the outdoor ambient temperature sensor 126 indicative of a temperature generally surrounding the outdoor heat exchanger 16 and may also receive a signal from the temperature sensor 106 disposed near the midpoint of the outdoor coil 26 indicative of the temperature near the midpoint of the outdoor coil 26. Once the sensor data is received by the outdoor control module 122, the outdoor control module 122 may determine a condenser temperature difference by subtracting the outdoor ambient temperature from the temperature near the midpoint of the outdoor coil 26.

The outdoor control module 122 may communicate the condenser temperature difference to the system control module 124. The system control module 124 may independently determine the condenser temperature difference based on the sensor data received from the outdoor control module 122. The system control module 124 may compare the determined condenser temperature difference to the condenser temperature difference received from the outdoor control module 122.

The suction superheat of the heat-pump system 12 may be determined by the outdoor control module 122 by subtracting a temperature of the indoor coil 38 from the temperature at the inlet of the compressor 14. As noted above, the outdoor control module 122 may receive a signal from the temperature sensor 102 disposed proximate to the inlet of the compressor 14 indicative of the suction temperature of the compressor 14 and may receive a signal from the temperature sensor 108 disposed near the midpoint of the indoor coil 38. Once the sensor data is received from the respective sensors 102, 108, the outdoor control module 122 may determine the suction superheat of the heat-pump system 12 by subtracting the temperature near the midpoint of the indoor coil 38 from the temperature near the inlet of the compressor 14.

The outdoor control module 122 may communicate the determined suction superheat to the system control module 124. The system control module 124 may independently determine the suction superheat of the heat-pump system 12 based on the sensor data received from the outdoor control module 122. The system control module 124 may compare the determined suction superheat of the heat-pump system 12 to the suction superheat value received from the outdoor control module 122.

When the heat-pump system 12 is operating in the heating mode, the discharge superheat of the heat-pump system 12 may be determined by the indoor control module 120 by subtracting a temperature near the midpoint of the indoor coil 38 from the discharge temperature of the compressor 14. As noted above, the indoor control module 120 may receive a signal from the temperature sensor 108 disposed near the midpoint of the indoor coil 38 and may also receive a signal from the temperature sensor 104 disposed proximate to an outlet of the compressor 14. Once the indoor control module 120 receives the sensor data from the respective sensors 104, 108, the indoor control module 120 may determine the discharge superheat of the heat-pump system 12 by subtracting the temperature near the midpoint of the indoor coil 38 from the discharge temperature of the compressor 14.

The indoor control module 120 may communicate the discharge superheat of the heat-pump system 12 to the system control module 124. The system control module 124 may independently determine the discharge superheat of the heat-pump system 12 based on the sensor data received from the indoor control module 120 and may compare the determined discharge superheat of the heat-pump system 12 to the discharge superheat value received from the indoor control module 120.

The subcooling of the heat-pump system 12 may be determined by the indoor control module 120 by subtracting a temperature proximate to the expansion valve 48 from the temperature near the midpoint of the indoor coil 38. As noted above, the indoor control module 120 may receive a signal from the temperature sensor 110 disposed proximate to an inlet of the expansion valve 48 and may receive a signal from the temperature sensor 108 disposed near the midpoint of the indoor coil 38. Once the sensor data is received from the respective sensors 108, 110, the indoor control module 120 may determine the subcooling of the heat-pump system 12 by subtracting the temperature proximate to the expansion valve 48 from the temperature near the midpoint of the indoor coil 38.

The indoor control module 120 may communicate the determined subcooling value of the heat-pump system 12 to the system control module 124. The system control module 124 may independently determine the subcooling of the heat-pump system 12 and may compare the determined subcooling value of the heat-pump system 12 to the subcooling value received from the indoor control module 120.

The condenser temperature difference may be determined by the indoor control module 120 by subtracting a temperature of the space to be heated from the temperature near the midpoint of the indoor coil 38. The indoor control module 120 may be in communication with the thermostat 118, as noted above. Therefore, the indoor control module 120 may receive sensor data from either the room temperature sensor 112 or the room relative humidity sensor 114 via the thermostat 118. The indoor control module 120 may receive the temperature near the midpoint of the indoor coil 38 from the temperature sensor 108 disposed near the midpoint of the indoor coil 38. Once the sensor data is received by the indoor control module 120, the indoor control module 120 may determine the condenser temperature difference by subtracting the temperature of the room to be heated from the temperature near the midpoint of the indoor coil 38.

The condenser temperature difference may be communicated to the system control module 124. The system control module 124 may independently determine the condenser temperature difference based on the sensor data received from the indoor control module 120 and may compare the determined condenser temperature difference to the condenser temperature difference received from the indoor control module 120.

The indoor control module 120 may determine the suction superheat of the heat-pump system 12 by subtracting the temperature near the midpoint of the outdoor coil 26 from the temperature near the inlet of the compressor 14. As noted above, the indoor control module 120 may receive a signal from a temperature sensor disposed near the midpoint of the outdoor coil 26 and may also receive a signal from the temperature sensor 102 disposed proximate to the inlet (i.e., the suction side) of the compressor 14. Once the sensor data is received from the respective sensors 102, 106, the indoor control module 120 may determine the suction superheat of the heat-pump system 12 by subtracting the temperature of the outdoor coil 26 from the temperature proximate to the inlet of the compressor 14.

The indoor control module 120 may communicate the determined suction superheat of the heat-pump system 12 to the system control module 124. The system control module 124 may independently determine the suction superheat of the heat-pump system 12 based on the sensor data received from the indoor control module 120 and may compare the determined suction superheat of the heat-pump system 12 to the suction superheat value received from the indoor control module 120.

The control and diagnostic system 10 and control and diagnostic system 100 may be in communication with system control modules 94, 124, respectively, for communication of data therebetween, as previously discussed. The system control modules 94, 124 may include generic system information such as, for example, compressor maps for use by the system control modules 94, 124 in confirming operating parameters received from the indoor control modules 72, 120 and outdoor control modules 74, 122, and also to diagnose the heat-pump system 12. The system control modules 94, 124 may be of the type disclosed in Assignee's commonly owned patent application Ser. Nos. 11/027,757 filed Dec. 30, 2004, and 60/831,755 filed Jul. 19, 2006, the disclosures of which are incorporated herein by reference. For example, the system control modules 94, 124 may use information received from the indoor control modules 72, 120 and outdoor control modules 74, 122 to diagnose the heat-pump system 12 to determine an efficiency and/or refrigerant charge of the heat-pump system 12 in addition to the foregoing system operating parameters discussed above.

1. A heat-pump system comprising:
a compressor;
an outdoor heat exchanger including an outdoor coil;
an indoor heat exchanger including an indoor coil;
a sensor assembly including a first sensor disposed in said outdoor coil, a second sensor disposed in said indoor coil, and a third sensor disposed between said outdoor heat exchanger and said indoor heat exchanger; and
a controller receiving data from said first sensor, said second sensor, and said third sensor to determine a first system operating parameter when the heat-pump system is operating in a cooling mode and a second system operating parameter when the heat-pump system is operating in a heating mode.

2. The heat-pump system of claim 1, wherein said first sensor, said second sensor, and said third sensor are temperature sensors.

3. The heat-pump system of claim 1, wherein said first system operating parameter is a subcooling of the heat-pump system and said second system operating parameter is a subcooling of the heat-pump system.

4. The heat-pump system of claim 1, wherein said third sensor is a liquid-line temperature sensor.

5. The heat-pump system of claim 4, wherein said controller determines said first system operating parameter by subtracting a liquid-line temperature measurement received from said third sensor from a temperature of said outdoor coil received from said first sensor when the heat-pump system is operating in said cooling mode and determines said second system operating parameter by subtracting said liquid-line temperature measurement received from said third sensor from a temperature of said indoor coil received from said second sensor when the heat-pump system is operating in said heating mode.

6. The heat-pump system of claim 1, further comprising an ambient temperature sensor in communication with said controller.

7. The heat-pump system of claim 6, wherein said controller receives temperature information from said first sensor indicative of a temperature of said outdoor coil and receives information from said ambient temperature sensor indicative of ambient temperature and determines a condenser temperature difference by subtracting said ambient temperature from said temperature of said outdoor coil when the heat-pump system is operating in said cooling mode.

8. The heat-pump system of claim 1, further comprising at least one of a room-temperature sensor and a room thermostat in communication with said controller and providing information to said controller indicative of a temperature of a space to be heated and/or cooled.

9. The heat-pump system of claim 8, wherein said controller receives information from said second sensor indicative of a temperature of said indoor coil and determines a condenser temperature difference by subtracting said room temperature from said temperature of said indoor coil when the heat-pump system is operating in said heating mode.

10. The heat-pump system of claim 1, further comprising a fourth sensor disposed proximate to said outdoor heat exchanger and a fifth sensor disposed proximate to said indoor heat exchanger.

11. The heat-pump system of claim 10, wherein said fourth sensor and said fifth sensor are in communication with said controller for use by said controller in determining at least one of said first system operating parameter and said second system operating parameter.

12. The heat-pump system of claim 11, wherein said controller receives information from said first sensor, said second sensor, said third sensor, said fourth sensor, and said fifth sensor to determine at least one of said first system operating parameter and said second system operating parameter, said first and second system operating parameters selected from the group comprising a discharge superheat of the heat-pump system, a subcooling of the heat-pump system, a condenser temperature difference, and a suction superheat of the heat-pump system.

13. The heat-pump system of claim 10, further comprising a sixth sensor disposed proximate to an outlet of said compressor and a seventh sensor disposed proximate to an inlet of said compressor, wherein said sixth and seventh sensors are in communication with said controller.

14. The heat-pump system of claim 13, wherein said controller uses information from said first sensor, said second sensor, said third sensor, said sixth sensor, and said seventh sensor to determine at least one of said first system operating parameter and said second system operating parameter, said first and second system operating parameters selected from the group comprising a discharge superheat of the heat-pump system, a subcooling of the heat-pump system, a condenser temperature difference, and a suction superheat of the heat-pump system.

15. The heat-pump system of claim 1, wherein said controller includes a first control module and a second control module.

16. The heat-pump system of claim 15, wherein one of said first control module and said second control module is associated with said outdoor heat exchanger and the other one of said first control module and said second control module is associated with said indoor control module.

17. The heat-pump system of claim 15, wherein said first control module is in communication with said second control module.

18. The heat-pump system of claim 1, further comprising at least one valve fluidly coupled to said outdoor heat exchanger and said indoor heat exchanger and operable to selectively regulate flow within the heat-pump system.

19. The heat-pump system of claim 18, wherein said controller is in communication with said at least one valve and controls said at least one valve based on information received from at least one of said sensor assembly, said first system operating parameter, and said second system operating parameter.

20. The heat-pump system of claim 1, wherein said controller is in communication with an external controller.

21.-45. (canceled)
